(19) United States
(12) Patent Application Publication
(10) Pub. No.: US 2014/0198750 A1
(43) Pub. Date: Jul. 17, 2014

(54) Multi-User (MU) Multiple-Input and Multiple-Output (MIMO) Enhancement

(71) Applicant: NEC Laboratories America, Inc., Princeton, NJ (US)

(72) Inventors: Narayan Prasad, Wyncote, PA (US); Guosen Yue, Plainsboro, NJ (US); Sampath Rangarajan, Bridgewater, NJ (US)

(73) Assignee: NEC Laboratories America, Inc., Princeton, NJ (US)

(21) Appl. No.: 14/156,043

(22) Filed: Jan. 15, 2014

Related U.S. Application Data
(60) Provisional application No. 61/753,739, filed on Jan. 17, 2013.

(51) Int. Cl. H04B 7/06; H04L 5/00; H04B 7/04

(52) U.S. Cl. CPC H04B 7/0626; H04B 7/0452; H04B 7/0478; H04L 5/0032
USPC 370/329

(57) ABSTRACT

A method implemented in a base station used in a mobile communications system is disclosed. The method includes configuring for a user equipment (UE) a channel state information (CSI) process for multi-user (MU) multiple-input and multiple-output (MIMO), the CSI process for MU-MIMO being associated with a channel part and an interference part, and according to the interference part, configuring the UE to measure or estimate inter-cell interference (ICI) and to compute or estimate intra-cell interference. Other apparatuses, systems, and methods also are disclosed.

This application claims the benefit of U.S. Provisional Application No. 61/753,739, entitled “Enhancements to DL MU-MIMO,” filed on Jan. 17, 2013, the contents of which are incorporated herein by reference.

### BACKGROUND OF THE INVENTION

The present invention relates to a mobile or wireless communications system and, more particularly, to channel state information (CSI) feedback in multi-user (MU) multiple-input and multiple-output (MIMO) operations.

In the recent RAN-1 meetings CQI/PMI reporting enhancements targeting downlink (DL) multi-user (MU) multiple-input and multiple-output (MIMO) operations were considered by several companies. In this document we briefly describe simple enhanced channel state information (CSI) reporting schemes that target an improvement in DL MU-MIMO performance. In particular, we first examine enhanced CSI reporting that includes an additional residual error norm feedback. This residual error norm captures the energy of the channel seen by a user that remains in the orthogonal complement of its reported precoder. Hence it is indicative of the interference that can potentially be caused to the user if it is co-scheduled with one or more other users. We then consider another enhanced CSI reporting scheme that includes additional CQI/PMI computed under the assumption of post-scheduling intra-cell interference (a.k.a. MU-CQI/PMI).

### REFERENCES

[1] NEC Group, “MU-MIMO: CQI Computation and PMI Selection,” 3GPP TSG RAN WG1 R1-103832.

[2] NEC Group ,“DL MU-MIMO enhancement via Residual Error Norm feedback,” 3GPP TSG RAN WG1 R1-113874.

### BRIEF SUMMARY OF THE INVENTION

An objective of the present invention is to provide an enhanced CSI reporting scheme under MU-MIMO operation.

An aspect of the present invention includes a method implemented in a base station used in a mobile communications system. The method comprises configuring for a user equipment (UE) a channel state information (CSI) process for multi-user (MU) multiple-input and multiple-output (MIMO), the CSI process for MU-MIMO being associated with a channel part and an interference part, and according to the interference part, configuring the UE to measure or estimate inter-cell interference (ICI) and to compute or estimate intra-cell interference.

Another aspect of the present invention includes a method implemented in a user equipment (UE) used in a mobile communications system. The method comprises receiving a channel state information (CSI) process for multi-user (MU) multiple-input and multiple-output (MIMO), the CSI process for MU-MIMO being associated with a channel part and an interference part, and according to the interference part, measuring or estimate inter-cell interference (ICI) and to compute or estimate intra-cell interference.

Still another aspect of the present invention includes a mobile communications system comprising a user equipment (UE) and a base station configuring for a user equipment (UE) a channel state information (CSI) process for multi-user (MU) multiple-input and multiple-output (MIMO), the CSI process for MU-MIMO being associated with a channel part and an interference part, wherein, according to the interference part, the UE is configured to measure or estimate inter-cell interference (ICI) and to compute or estimate intra-cell interference.

### BRIEF DESCRIPTION OF THE DRAWINGS

FIG. 1 depicts an MU-MIMO network system.

FIG. 2 depicts a detailed block diagram for a method disclosed herein.

FIG. 3 depicts another detailed block diagram for a method disclosed herein.

FIG. 4 depicts still another detailed block diagram for a method disclosed herein.

### DETAILED DESCRIPTION

1. Enhanced MU-MIMO operation via Residual Error Norm Feedback

Under this scheme when configured by the eNB, the user reports SU-MIMO CSI plus a residual error term. The eNB can configure a user (to report the additional feedback) in a semi-static manner. We consider a simple form of residual error referred to as the residual error norm. Using SU-MIMO rules the user of interest first determines the SU-MIMO CSI comprising of a PMI \hat{V} of some rank r along with r quantized signal-to-interference-plus-noise ratios (SINRs) {ŜINRⁱ}ᵢ₌₁^{r}. Note that r can be determined by the user or it can be enforced by the eNB via codebook subset restriction. The residual error norm is determined by the user as \tilde{ε}=\sqrt{tr(FH^{†}PHF^{†})}, where tr(.) denotes the trace operation, H^{†} denotes the channel matrix seen in the DL by the user of interest and F denotes the filter matrix it computes for SU-MIMO CSI generation¹ and P=(I−\hat{V}\hat{V}^{†}) is a projection matrix. Note that \tilde{ε} represents the residual total energy in the component of the filtered channel that lies in the orthogonal complement of the reported precoder \hat{V}. The user reports the usual SU-MIMO CSI along with the residual error norm \tilde{ε} or a normalized residual error norm ε computed using ε=\sqrt{tr(FH^{†}PHF^{†}\tilde{D}⁻¹)}, where \tilde{D}=diag{ŜINR¹, . . . , ŜINR^{r}}. The eNB can use the residual error norms reported by the users to determine accurate SINRs for any choice of user pairing in MU-MIMO. To achieve this, consider the case when the pairing includes the user of interest. The eNB employs a finer approximation of the filtered channel matrix (FH^{†}) of the user given by FH^{†}≈\hat{D}^{1/2}(\hat{V}^{†}+R^{†}Q^{†}), where Q∈ [symbol] ^{M×M-r} is a semi-unitary matrix whose columns lie in the orthogonal complement of \hat{V}, i.e. Q^{†}\hat{V}=0 and R∈ [symbol] ^{M-r×r} is a matrix which satisfies the Frobenius-norm constraint ∥R∥_{F}²=ρ/rε², where ε>0 is the normalized residual error norm reported by the user and ρ denotes the energy per resource element (EPRE) or equivalently an average transmit power or average transit power bound configured for that user, while \hat{D}=r/ρdiag{ŜINR¹, . . . , ŜINR^{r}}. Then, suppose the transmit precoder selected by the eNB, U, is parsed as U=[U,Ū], where Ū includes columns of the transmit precoder matrix intended for the other co-scheduled (paired) users. For a well designed transmit precoder, the eNB can make the reasonable assumption that U (almost) lies in the span of \hat{V} whose columns represent the preferred directions along which the user wishes to receive its intended signal (so that Q^{†}U≈0). Accordingly, a model more tuned to MU-MIMO operation can be obtained in which the channel output seen by the user of interest post MU-MIMO scheduling is modeled as

y=\hat{D}^{1/2}\hat{V}^{†}Us+\hat{D}^{1/2}(\hat{V}^{†}+R^{†}Q^{†})Ū s̅+η, (1)

The model in (1) accounts for the fact that the component of Ū in the orthogonal complement of \hat{V} can also cause interference to the user. Notice that when only SU-MIMO CSI along with the normalized residual error norm is reported by the users, in the model in (1) the eNB can only infer that the semi-unitary matrix Q lies in the subspace determined by I−\hat{V}\hat{V}^{†} and R is also not known except for the fact that tr(R^{†}R)=ρ/rε².

In [2] we describe how the eNB can utilize the model in (1) for MU-MIMO SINR computation.

¹ We can assume that a whitening operation to suppress inter-cell interference (ICI) is done and the whitening matrix is absorbed into the matrix H^{†} while the filter matrix F considers mutual interference among streams assigned to the user of interest. Alternatively, the matrix F can consider and suppress ICI as well.

1.1 Re-interpreting Residual Error Norm (REN)

Recall that the REN is given by the expression \tilde{ε}=\sqrt{tr(FH^{†}PHF^{†})}, where P=I−\hat{V}\hat{V}^{†}. Indeed the covariance matrix of the random vector z isotropically distributed in the range of the projection P is equal to E[zz^{†}]=δP, where δ>0 is a scalar. Consequently, since tr(FH^{†}E[zz^{†}]HF^{†})=E[z^{†}HF^{†}FH^{†}z], we can see that REN is equal (upto a scaling factor) to the average received power (equivalently the SINR under SU transmission) of a signal sent along a precoding vector that is distributed istropically in the range of P and where the filter F is used by the receiver. This insight leads to the observation that the REN can be approximated by considering a codebook subset formed by vectors in the codebook that are orthogonal to \hat{V} and then computing the SINRs (or channel quality indicators (CQIs)) for each one of them using SU-MIMO rules, where the filtered channel matrix FH^{†} is used as the effective channel matrix² and finally averaging those SINRs.

² When \hat{V} is a rank one vector we can ignore F.

2. Enhanced MU-MIMO operation via MU-MIMO CQI and PMI

Under this scheme the user itself assumes a post-scheduling model of the form

y=H^{†}\hat{V}s+H^{†}Ū s̅+η, (2)

where \hat{V} denotes the precoder under consideration (or determined a-priori using SU-MIMO rules) and Ū is assumed by the user to be isotropically distributed in the range of I−\hat{V}\hat{V}^{†}. Then, to compute MU-SINRs the user can be configured to assume a particular number of columns in Ū with an equal power per scheduled stream or to assume a non-uniform power allocation in which a certain fraction of EPRE is shared equally among all columns of U with the remaining fraction being shared equally among all columns in Ū [1].

3. More Enhanced User Feedback

We first note that the residual error, i.e., the component of the filtered user channel FH^{†} in the orthogonal complement of \hat{V} is given by (I−\hat{V}\hat{V}^{†})HF^{†}. After normalization using \tilde{D}, this component becomes (I−\hat{V}\hat{V}^{†})HF^{†}\tilde{D}^{-1/2}. The user reports \hat{V} as well as \tilde{D}. In addition, the user can report some information about the normalized component in the orthogonal complement (normalized residual error). As aforementioned, a simple option is to report the normalized residual error norm

ε=\sqrt{tr(FH_{\}PHF_{\}\tilde{D}⁻¹).} (3)

More involved options can enable even more accurate SINR computation at the eNB for any choice of user pairing in MU-MIMO. These include the following:

User-1 obtains the QR decomposition of (I−\hat{V}\hat{V}^{†})HF_{\}\tilde{D}^{-1/2} given by

(I−\hat{V}\hat{V}^{†})HF_{\}\tilde{D}^{-1/2}=Q′R′, (4)

where Q′∈ [symbol] ^{M×M-r} is a semi-unitary matrix whose columns lie in the orthogonal complement of \hat{V}, i.e. Q′^{†}\hat{V}=0 and R′∈ [symbol] ^{M-r×r} is a matrix which satisfies the Frobenius-norm constraint ∥R′∥_{F}²=ε², where ε is the normalized residual error norm. Notice that the matrix Q′ in (4) is the same as Q in (1), whereas R=\sqrt{ρ/r}R′. Then, the user-1 can report the first few largest diagonal values of R′ along with the corresponding columns of Q after quantizing them. In addition, it can also report the normalized residual error norm ε. The number of diagonal values of R′ to be reported can be configured by the eNB or the user can report all diagonal values greater than a threshold specified by the eNB. The eNB receives this report and employs it for SINR computation.

In another form of residual error feedback the user can obtain the singular value decomposition of (I−\hat{V}\hat{V}^{†})HF^{†}\tilde{D}^{-1/2} given by

(I−\hat{V}\hat{V}^{†})HF_{\}\tilde{D}^{-1/2}=Ũ\tilde{S}\tilde{W}_{\}, (5)

where U∈ [symbol] ^{M×M-r} and \tilde{W}∈ [symbol] ^{r×r} are semi-unitary and unitary matrices, respectively, and the diagonal values of \tilde{S} are the singular values. Then, the user-1 can report the first few largest singular values in \tilde{S} along with the corresponding columns of Ũ after quantizing them. In addition, it can also report the normalized residual error norm ε. The number of singular values to be reported can be configured by the eNB or the user can report all singular values greater than a threshold specified by the eNB. The eNB receives this report and employs it for SINR computation.

4. Signaling Enhanced User Feedback

In each channel state information (CSI) reporting interval the user reports its CSI. The eNB can configure a user for peiodic CSI reporting and fix the periodicity and offset which together determine the exact sequence of intervals for which the user should report its CSI. This sequence will be henceforth referred to as the sequence for CSI reporting.

4.1 Multiplexing enhanced and Baseline CSI Feedback

In order to obtain the benefits of accurate MU-MIMO SINR computation without excessive feedback overhead, the eNB can multiplex intervals in which the user reports enhanced feedback with the ones in which it reports only its SU-MIMO CSI feedback. The periodicity and offset of the sub-sequence formed by intervals designated for enhanced feedback within the sequence for CSI reporting can be configured by the eNB, based on factors such as user mobility. Then, we have the following points that are of particular interest:

In the sequence for CSI reporting, in the intervals designated for only SU-MIMO CSI feedback, the user reports its preferred precoder matrix \hat{V} and the corresponding quantized SINRs (determined using SU-MIMO rules). The user can select its preferred precoder matrix from a codebook of matrices under the constraint that it must be of a particular rank specified by the eNB or belong to a codebook subset specified by the eNB, or it can freely choose its preferred precoder matrix if no restrictions have been imposed by the eNB.

In each interval designated for enhanced feedback, the user can first determine its SU-MIMO CSI comprising of a precoder \hat{V} and corresponding SINRs using SU-MIMO rules. As aforementioned, the user follows the restriction (if any) on rank or codebook subset that has been imposed by the eNB. The user uses \hat{V} and \tilde{D} (formed by the corresponding quantized SINRs) to determine any one of the forms of the residual error feedback described above. The particular feedback form will be configured by the eNB. The user then reports its SU-MIMO CSI along with the particular residual error feedback form. Differential feedback can be exploited in reporting the SU-MIMO CSI and the residual error feedback form. For instance, if the residual error feedback form consists of only the quantized residual error norm, then the user can report the SU-MIMO CSI and the difference of the largest (or smallest) reported SU-MIMO SINR and the residual error norm. The user adopted convention for differential feedback is also configured by the eNB allowing it to reconstruct the residual error feedback form.

Alternatively, in each interval designated for enhanced feedback, the user can first determine its SU-MIMO CSI under a restriction on rank or codebook subset that has been imposed by the eNB, where the said restriction applies only to intervals designated for enhanced feedback. The eNB can freely choose any restriction for the other intervals in the sequence for CSI reporting. The user then uses the determined precoder \hat{V} and \tilde{D} (formed by the corresponding quantized SINRs) to determine the eNB configured residual error feedback form and reports it along with its SU-MIMO CSI.

Another option for each interval designated for enhanced feedback is also possible. Here the rank of the precoder \hat{V} to be determined via SU-MIMO rules, can itself be a function of the previous S ranks of the precoders selected by the user in the previous S intervals designated for only SU-MIMO CSI feedback. The function is pre-defined and known to both the user and the eNB. An example is where S=1 and the rule is that rank selected for the current interval designated for enhanced feedback is equal to one when the rank in the previous interval designated for only SU-MIMO CSI feedback is also equal to one; and the rank in the current interval is two otherwise. Alternatively, \hat{V} itself can be a function of the previous S precoders (and their corresponding SINRs) selected by the user in the previous S intervals designated for only SU-MIMO CSI feedback. The function is pre-defined and known to both the user and the eNB. In this case \hat{V} need not be reported by the user since it can be deduced by the eNB.

Note that special cases of the sequence for CSI reporting described above, are the baseline case where each interval in the sequence is designated for SU-MIMO CSI only feedback and the one where each interval in the sequence is designated for enhanced feedback. Finally, as an option to reduce feedback overhead, in all the aforementioned alternatives the CSI reports can include a wideband precoder matrix (i.e., a precoder matrix common for all sub-bands) along with sub-band specific SINRs and sub-band specific residual error feedback forms.

4.2 Combining Eenhanced and Baseline Feedback

In order to obtain full benefits of accurate MU-MIMO SINR computation and scheduling flexibility, we can combine SU-MIMO CSI reporting and enhanced CSI reporting. Then, we have the following points of particular interest:

In each interval, the user can first determine its preferred precoder matrix Ĝ and the corresponding quantized SINRs using SU-MIMO rules. The user can select its preferred precoder matrix under the constraint that it must be of a particular rank specified by the eNB or belong to a codebook subset specified by the eNB, or it can freely choose its preferred precoder matrix if no restrictions have been imposed by the eNB. Next, in the same interval the user can determine another precoder matrix \hat{V} and corresponding SINRs using SU-MIMO rules. The eNB can set a separate restriction on rank or codebook subset which \hat{V} must obey. Notice in this case that if the rank enforced on \hat{V} happens to be equal to that of Ĝ, then \hat{V} and its corresponding quantized SINRs need not be reported since they are identical to Ĝ and its corresponding quantized SINRs, respectively, since both the pairs are determined using SU-MIMO rules. Alternatively, the rank of precoder \hat{V} can itself be a function of the rank of Ĝ. The function is pre-defined and known to both the user and the eNB. An example rule is where rank of \hat{V} must be equal to one when the rank of Ĝ is one; and the rank of \hat{V} is two otherwise. In either case, using \hat{V} along with the corresponding SINRs, the user determines the eNB configured residual error feedback form. The user feedback report now includes Ĝ and corresponding quantized SINRs as well as \hat{V}, its corresponding quantized SINRs and the residual error feedback form. Again, differential feedback can be exploited in reporting this CSI.

Alternatively, \hat{V} itself can be a function of Ĝ and the SINRs corresponding to Ĝ and thus need not be reported since the function is pre-defined and known to both the user and the eNB. For instance, \hat{V} can be the column of Ĝ for which the corresponding SINR is the largest among all SINRs corresponding to Ĝ. Note here that if \hat{V} is identical to Ĝ then even the quantized SINRs corresponding to \hat{V} need not be reported since they are identical, respectively, to the quantized SINRs corresponding to Ĝ.

Finally, as an option to reduce feedback overhead, in all the aforementioned alternatives the CSI reports can include wideband Ĝ,\hat{V} along with sub-band specific SINRs and sub-band specific residual error feedback forms.

5. Signaling Enhanced User Feedback via Multiple CSI processes

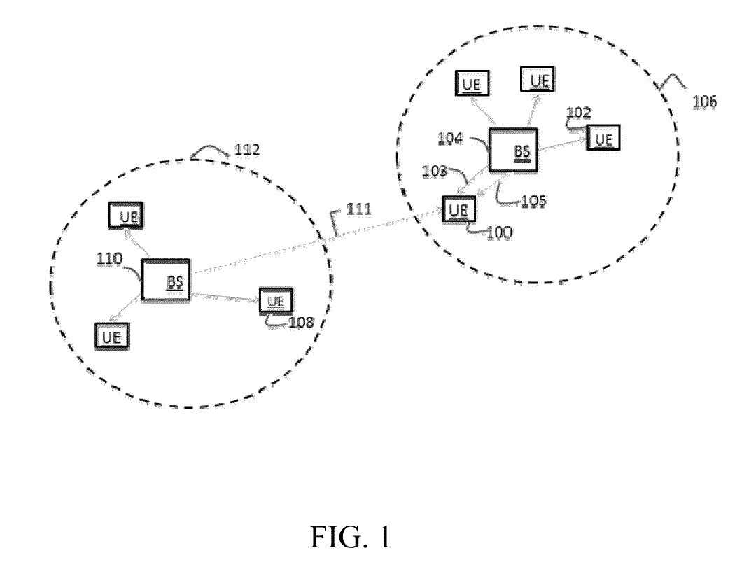

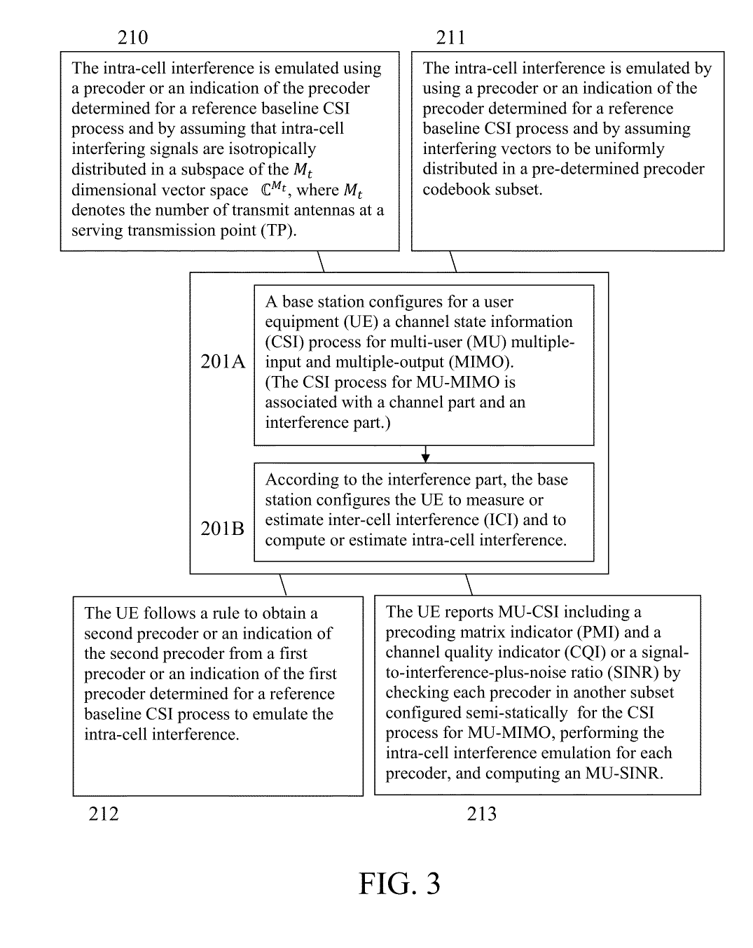

Notice that CSI is computed by the user under the assumption of a transmission hypothesis. For instance, referring to FIG. 1, SU-MIMO CSI is computed by user or user equipment (UE) 100 under the assumption that it alone would be served 103 by the eNB (or transmission point (TP) or base station A04 in its cell 106) and no other user 102 will be co-scheduled with it on its assigned RBs, so that there is no intra-cell interference 105 but only inter-cell interference (ICI) 111 due to transmissions by TPs 110 of other cells 112. On the other hand, MU-MIMO CSI is computed by user 100 under the assumption that other users 102 will be co-scheduled so that there will be intra-cell interference 105 post-scheduling as well. In general we can capture each hypothesis using the mechanism of a CSI-process which is associated with one “channel part” which represents the channel seen from the serving TP (or equivalently a non-zero power (NZP) CSI-RS resource using which a channel estimate can be obtained) and one “interference part” (Block 201A in FIG. 2). This interference part can in turn be associated with a set of REs (which is a zero-power (ZP) CSI-RS resource referred to as the interference measurement resource (IMR)) (Block 204 in FIG. 2). The UE can be simply told to directly measure or estimate the covariance matrix of the interference³ on those REs and it is up-to the controller to configure on those REs the interference it wants the UE to measure. Alternatively, the UE can be configured to measure the interference on an IMR (for instance the interference from outside the cell) (Block 201B in FIG. 2) and also emulate additional intra-cell interference using the channel estimate (Block 201B in FIG. 2) determined for the serving TP (Block 202 in FIG. 2) from the corresponding NZP CSI-RS resource (Block 203 in FIG. 2). Each CSI process can define multiple intervals over which the UE should measure and report its CSI (Block 205 in FIG. 2), for instance, the sequence of intervals containing the NZP-CSI-RS resources can be configured by the controller for that UE along with the sequence containing the IMRs, wherein each set of IMR REs is associated with a set of NZP-CSI-RS REs (Block 206 in FIG. 2). The UE then uses each such pair of associated sets to compute its CSI and report it.

³ For brevity we will henceforth drop the term “covariance matrix” and just use “measure/estimate the interference.”

We note that to achieve the maximal MU-MIMO gains, the network can allow multiple CSI-processes to be configured for a UE, with different IMRs and/or different rules for emulation of respective interferences and compuatation of respective CSI (Block 208 in FIG. 2). As a baseline, the SU-MIMO feedback can be obtained by a CSI-process in which the IMR is configured for the UE to measure the ICI and the NZP-CSI-RS resource is configured to allow the UE to obtain a channel estimate from the serving TP in its cell (Block 207 in FIG. 2). A special value for the IMR would be a default value which indicates that no REs have been reserved to allow the UE to directly measure inter-cell interference (ICI). In this case the UE could for instance first estimate the channel from the NZP CSI-RS resource REs and then use the same REs for ICI estimation (after subtracting the product of the estimated channel and the reference symbols) as well.

In order to limit the overhead and complexity a limit can be placed on the number of distinct CSI-processes that can be configured for a UE. A good value for such a limit is two (Block 209 in FIG. 2). Before proceeding, we note that the “sequence of intervals in which the UE reports only its SU-MIMO CSI feedback” as discussed in Section 4.1 can equivalently be described by the baseline CSI-process discussed here. Similarly, each example of “the sequence of intervals in which the UE reports its enhanced feedback” discussed in Section 4.1 is equivalent to another CSI-process, for which a different rule for CSI computation has been configured. We consider some examples of CSI processes in the following:

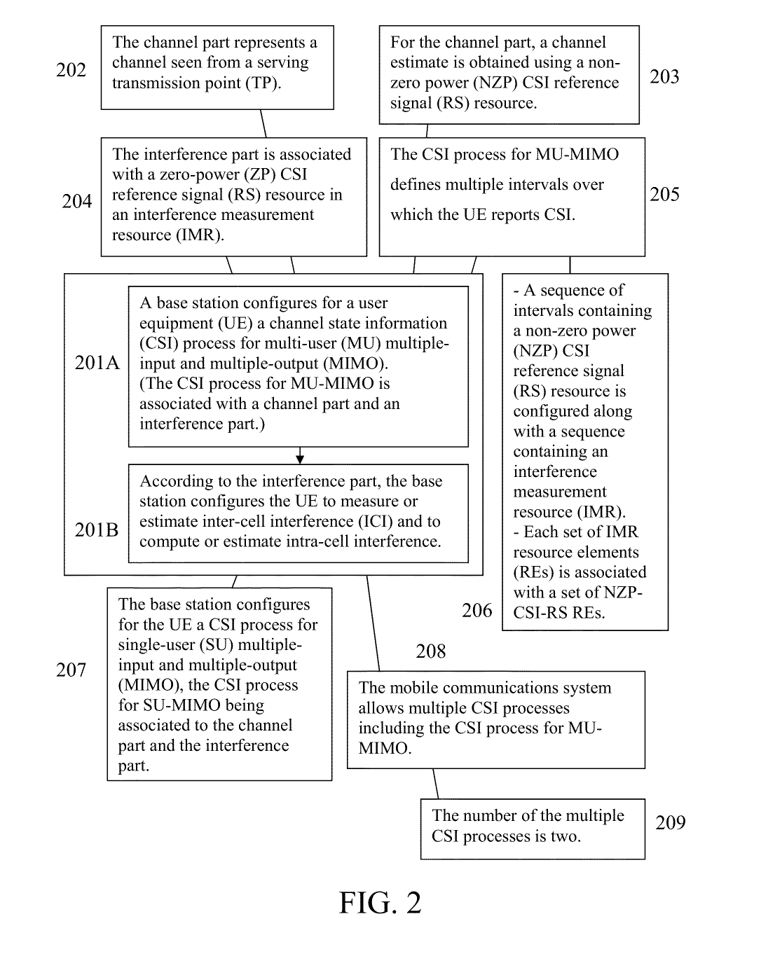

(a) To enable MU-MIMO CSI computation at the UE a CSI-process can be configured as follows. The UE can be configured to measure the ICI on an IMR (or using other REs when no IMR is assigned as described before) and also emulate additional intra-cell interference. The UE can be configured to do this emulation using the precoder determined for another reference baseline CSI-process and after assuming that the intra-cell interfering signals are isotropically distributed in a subspace of the the Mₜ dimensional vector space [symbol] ^{M}_{^{t}}, where Mₜ denotes the number of transmit antennas at the serving TP (Block 310 in FIG. 3). This subspace can be defined as the range of I−\hat{V}\hat{V}_{\}, where \hat{V} denotes the precoder that has been determined and reported by the user for (a corresponding interval in) the reference baseline CSI process (Block 311 in FIG. 3). The intuition here is that \hat{V} represents the preferred directions along which the user wishes to receive its data so a good MU-MIMO transmit precoder should ensure that the data for co-scheduled users is sent along directions (vectors) in the orthogonal complement, I−\hat{V}\hat{V}_{\}. We note that the covariance matrix of such interference is αρH_{\}(I−\hat{V}\hat{V}_{\})H where the factor a can be used by the controller to semi-statically control the UE's assumption about intra-cell interference power. Alternatively, instead of assuming an isotropic distribution, the UE can compute the intra-cell interference by assuming the interfering vectors to be uniformly distributed in a pre-determined precoder codebook subset, where one such subset (along with a power scaling factor) can be configured semi-statically for each possible choice of \hat{V}. Note that in either case only the MU-SINRs need to be computed and reported.

(b) Instead of directly using the PMI of the reference baseline CSI process, the UE can be configured to follow rules to obtain the PMI from those determined in the reference baseline CSI process (Block 312 in FIG. 3), in the same manner as described in Section 4.1 for deriving the PMI to be used in the interval for enhanced CSI reporting from those determined in the intervals designated as SU-MIMO CSI feedback intervals.

(c) The eNB can configure the UE to determine MU-CSI (including both PMI and CQIs) without using the PMI of the baseline process. In this case the UE can systematically check each precoder V in another subset configured semi-statically for that process and for each V it can perform the intra-cell interference emulation as described above and compute MU-SINRs (Block 313 in FIG. 3). The UE then selects a PMI and reports it along with the corresponding SINRs.

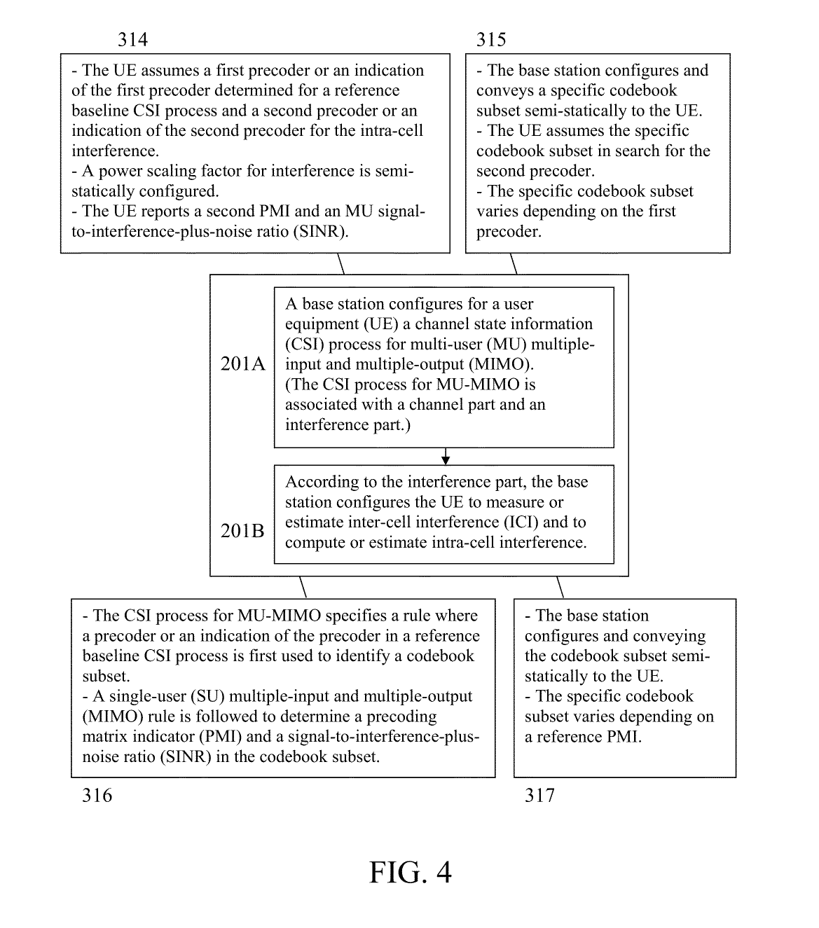

(d) In another variation, the UE can be configured to assume one (intra-cell) interferer. In particular, the PMI \hat{V} from the reference baseline process is assumed to be the desired PMI (along which the desired signal would be sent) and another companion PMI \hat{V} is also determined, which the UE assumes to the intra-cell interferer (one along which the signal for the co-scheduled user would be sent).The power scaling factor that the UE should assume for the interferer can be semi-statically configured. The UE then determines and reports the companion PMI along with the MU-SINRs (Block 414 in FIG. 4). Additionally, the UE can be configured to assume a specific codebook subset in its search for the companion PMI, where this subset is configured and conveyed semi-statically to it by the eNB and the choice of subset itself can vary with that of the desired PMI \hat{V} (Block 415 in FIG. 4).

(e) As mentioned earlier, each example of “the sequence of intervals in which the UE reports its enhanced feedback” as discussed in Section 4.1 can be equivalently described by a CSI-process. This process specifies a rule for computing a residual error feedback form. The UE computes the CSI accordingly and reports it. The re-interpretation of the REN described in Section 1.1 can for instance be used to design such a rule.

(f) Simple dependencies in the CSI computation rules can be introduced across different CSI processes. For instance a CSI process can specify a rule where the PMI in the reference baseline process, \hat{V}, is first used to identify a codebook subset. Then SU-MIMO rules are followed to determine a suitable PMI (along with the corresponding SINRs) in that subset (Block 416 in FIG. 4). This subset is configured and conveyed semi-statically to the user by the eNB and the choice of subset itself can vary with that of the reference PMI \hat{V} (Block 417 in FIG. 4). One example of a subset for any particular \hat{V} is that formed by precoders that are orthogonal to {circumflex over (\hat{V}. In this case it can be seen that the CSI rule described above specifies an enhanced feedback form (Section 3) since the PMI and SINRs so obtained enable an approximation of the component of the channel matrix in the orthogonal complement of \hat{V}.

We can define the notion of a CSI-pattern that comprises of a set of CSI-processes. A codebook of such patterns can be defined and disclosed to the UE in a semi-static manner. Then, the controller can dynamically or semi-statically signal an index from the codebook to the UE which identifies a pattern. The UE can then compute CSI as per the rule defined for each CSI-process in that pattern and feed them back. In case of semi-static signaling the UE can be configured to follow the most recently signaled pattern until a new one is signaled to it. To reduce the overhead, while defining a pattern one or more of its CSI-processes can be marked CQI-only, i.e, the UE does not compute PMI/RI in the CSI computed for these CSI-processes. Instead, for each such process it will use the PMI of another CSI process in that pattern which is indicated to be the reference for that process. The reference process whose PMI is to be used is also fixed separately for each such CQI-only marked process. Furthermore, some processes can be marked as those requiring wideband PMI and/or wideband CQI(s) and consequently, the UE will only compute and report wideband PMI and/or wideband CQI(s) for such processes. Additionally, a separate codebook subset restriction can be placed on each process and/or a separate maximum rank limit can be placed on each process. Optionally, a common rank restriction can be imposed on all processes in a pattern. Further specializing this restriction, a CSI process in the pattern can be marked to indicate that the UE should first compute CSI (including RI) for that process and then use the computed RI for all the remaining processes. All such optimizations can be done semi-statically while defining a codebook and the codebook and attributes (or markings) of each process in each pattern in the codebook are conveyed to the UE semi-statically. Then the index of a pattern can be conveyed in a dynamic manner and the UE will report CSI following the indexed pattern and the attributes and rules of its constituent CSI processes. Notice that the codebook can be defined on a UE-specific manner. Alternatively, a codebook can be defined in a cell-specific manner so that each UE can know the codebook based on its assigned cell.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method implemented in a base station used in a mobile communications system, the method comprising:
configuring for a user equipment (UE) a channel state information (CSI) process for multi-user (MU) multiple-input and multiple-output (MIMO), the CSI process for MU-MIMO being associated with a channel part and an interference part; and
according to the interference part, configuring the UE to measure or estimate inter-cell interference (ICI) and to compute or estimate intra-cell interference.

2. The method as in claim 1,
wherein the channel part represents a channel seen from a serving transmission point (TP).

3. The method as in claim 1,
wherein, for the channel part, a channel estimate is obtained using a non-zero power (NZP) CSI reference signal (RS) resource.

4. The method as in claim 1,
wherein the interference part is associated with a zero-power (ZP) CSI reference signal (RS) resource in an interference measurement resource (IMR).

5. The method as in claim 1,
wherein the CSI process for MU-MIMO defines multiple intervals over which the UE reports CSI.

6. The method as in claim 5,
wherein a sequence of intervals containing a non-zero power (NZP) CSI reference signal (RS) resource is configured along with a sequence containing an interference measurement resource (IMR), and
wherein each set of IMR resource elements (REs) is associated with a set of NZP-CSI-RS REs.

7. The method as in claim 1, further comprising:
configuring for the UE a CSI process for single-user (SU) multiple-input and multiple-output (MIMO), the CSI process for SU-MIMO being associated to the channel part and the interference part.

8. The method as in claim 1,
wherein the mobile communications system allows multiple CSI processes including the CSI process for MU-MIMO.

9. The method as in claim 8,
wherein the number of the multiple CSI processes is two.

10. The method as in claim 1,
wherein the intra-cell interference is emulated using a precoder or an indication of the precoder determined for a reference baseline CSI process and by assuming that intra-cell interfering signals are isotropically distributed in a subspace of the Mₜ dimensional vector space [symbol] ^{M}^{ₜ}, where Mₜ denotes the number of transmit antennas at a serving transmission point (TP).

11. The method as in claim 1,
wherein the intra-cell interference is emulated by using a precoder or an indication of the precoder determined for a reference baseline CSI process and by assuming interfering vectors to be uniformly distributed in a pre-determined precoder codebook subset.

12. The method as in claim 1,
wherein the UE follows a rule to obtain a second precoder or an indication of the second precoder from a first precoder or an indication of the first precoder determined for a reference baseline CSI process to emulate the intra-cell interference.

13. The method as in claim 1,
wherein the UE reports MU-CSI including a precoding matrix indicator (PMI) and a channel quality indicator (CQI) or a signal-to-interference-plus-noise ratio (SINR) by checking each precoder in another subset configured semi-statically for the CSI process for MU-MIMO, performing the intra-cell interference emulation for each precoder, and computing an MU-SINR.

14. The method as in claim 1,
wherein the UE assumes a first precoder or an indication of the first precoder determined for a reference baseline CSI process and a second precoder or an indication of the second precoder for the intra-cell interference,
wherein a power scaling factor for interference is semi-statically configured, and
wherein the UE reports a second PMI and an MU signal-to-interference-plus-noise ratio (SINR).

15. The method as in claim 14, further comprising:
configuring and conveying a specific codebook subset semi-statically to the UE,
wherein the UE assumes the specific codebook subset in search for the second precoder, and
wherein the specific codebook subset varies depending on the first precoder.

16. The method as in claim 1,
wherein the CSI process for MU-MIMO specifies a rule where a precoder or an indication of the precoder in a reference baseline CSI process is first used to identify a codebook subset, and
wherein a single-user (SU) multiple-input and multiple-output (MIMO) rule is followed to determine a precoding matrix indicator (PMI) and a signal-to-interference-plus-noise ratio (SINR) in the codebook subset.

17. The method as in claim 16, further comprising:
configuring and conveying the codebook subset semi-statically to the UE,
wherein the specific codebook subset varies depending on a reference PMI.

18. A method implemented in a user equipment (UE) used in a mobile communications system, the method comprising:
receiving a channel state information (CSI) process for multi-user (MU) multiple-input and multiple-output (MIMO), the CSI process for MU-MIMO being associated with a channel part and an interference part; and
according to the interference part, measuring or estimate inter-cell interference (ICI) and to compute or estimate intra-cell interference.

19. A mobile communications system comprising:
a user equipment (UE); and
a base station configuring for a user equipment (UE) a channel state information (CSI) process for multi-user (MU) multiple-input and multiple-output (MIMO), the CSI process for MU-MIMO being associated with a channel part and an interference part,
wherein, according to the interference part, the UE is configured to measure or estimate inter-cell interference (ICI) and to compute or estimate intra-cell interference.
